(19) United States
(12) Patent Application Publication
(10) Pub. No.: US 2018/0233059 A1
(43) Pub. Date: Aug. 16, 2018

(54) Methods and Systems for Improving Patient Outcomes

(71) Applicant: Rosalind Franklin University of Medicine and Science, North Chicago, IL (US)

(72) Inventors: Tamzin J. Batteson, Oswego, IL (US); Sarah S. Garber, Highland Park, IL (US)

(21) Appl. No.: 15/433,703

(22) Filed: Feb. 15, 2017

(51) Int. Cl. G09B 9/00; G09B 23/30; G09B 7/02; G09B 7/10; G09B 19/00

(52) U.S. Cl. CPC G09B 9/00; G09B 23/30; G09B 19/00; G09B 7/10; G09B 7/02

(57) ABSTRACT

In one aspect, a method for improving patient outcome is disclosed. The method includes (i) observing a first interview of a simulated patient, wherein, during the first interview, the simulated patient is in a first form; (ii) participating in a second interview of the simulated patient, wherein, during the second interview, the simulated patient is in a second form, and wherein participating in the second interview comprises interacting with the simulated patient; (iii) participating in a third interview of the simulated patient, wherein, during the third interview, the simulated patient is in the first form, and wherein participating in the third interview comprises interacting with the simulated patient; and (iv) based at least in part on the first, second, and third interviews, creating a plan of care for the simulated patient.

### BACKGROUND

Various health professionals, such as medical doctors, nurses, psychiatrists, and the like interact with patients on a day-to-day basis. The quality of care that a health professional provides to a patient may depend on interactions between the health professional and the patient as well as on interactions between the health professional and other health professionals.

### SUMMARY

In order to improve the quality of care that a health professional provides to a patient, the health professional may become competent in patient-centered interprofessional collaborative practice. In order to facilitate this, a four-stage framework has been developed to define various competency domains. The four-stage framework may include competencies based on interprofessional values and ethics, roles and responsibilities, communication, and teams and teamwork. A health professional proficient in each of these competencies may be able to provide improved patient outcomes compared to a health professional that is not proficient in these competencies. Accordingly, disclosed herein are methods and systems for teaching these competencies to various health professionals and/or to students training to become health professionals.

In one aspect, a method for improving patient outcome is disclosed. The method includes (i) observing a first interview of a simulated patient, wherein, during the first interview, the simulated patient is in a first form; (ii) participating in a second interview of the simulated patient, wherein, during the second interview, the simulated patient is in a second form, and wherein participating in the second interview comprises interacting with the simulated patient; (iii) participating in a third interview of the simulated patient, wherein, during the third interview, the simulated patient is in the first form, and wherein participating in the third interview comprises interacting with the simulated patient; and (iv) based at least in part on the first, second, and third interviews, creating a plan of care for the simulated patient.

In another aspect, a system for improving patient outcome is disclosed. The system can include a user interface, a processor, and a computer readable medium storing program instructions that are executable by the processor to perform operations. The operations include (i) displaying, via the user interface, a first interview of a simulated patient, wherein, during the first interview, the simulated patient is displayed in a first form; (ii) displaying, via the user interface, a second interview of the simulated patient, wherein, during the second interview, the simulated patient is displayed in a second form; (iii) during the second interview, receiving, via the user interface, one or more inquiries for the simulated patient and outputting, via the user interface, one or more responses to the one or more inquiries; (iv) displaying, via the user interface, a third interview of the simulated patient, wherein, during the third interview, the simulated patient is displayed in the first form; (v) during the third interview, receiving, via the user interface, one or more inquiries for the simulated patient and outputting, via the user interface, one or more responses to the one or more inquiries; and (vi) receiving, via the user interface, a plan of care for the simulated patient, wherein the plan of care is based at least in part on the first, second, and third interviews.

In yet another aspect, a non-transitory computer readable medium is disclosed. The non-transitory computer readable medium stores executable instructions that, when executed by a processor of a computing device, cause the computing device to perform operations for improving patient outcome. Such operations include (i) displaying, via a user interface of the computing device, a first questionnaire including a first self-evaluation and receiving, via the user interface, one or more answers to the first questionnaire; (ii) displaying, via the user interface, a first interview of a simulated patient, wherein, during the first interview, the simulated patient is displayed in a first form; (iii) displaying, via the user interface, a second questionnaire including a second self-evaluation and receiving, via the user interface, one or more answers to the second questionnaire; (iv) displaying, via the user interface, a second interview of the simulated patient, wherein, during the second interview, the simulated patient is displayed in a second form; (v) during the second interview, receiving, via the user interface, one or more inquiries for the simulated patient and outputting, via the user interface, one or more responses to the one or more inquiries; (vi) displaying, via the user interface, a third questionnaire including a third self-evaluation and receiving, via the user interface, one or more answers to the third questionnaire; (vii) displaying, via the user interface, a third interview of the simulated patient, wherein, during the third interview, the simulated patient is displayed in the first form; (viii) during the third interview, receiving, via the user interface, one or more inquiries for the simulated patient and outputting, via the user interface, one or more responses to the one or more inquiries; (ix) receiving, via the user interface, a plan of care for the simulated patient, wherein the plan of care is based at least in part on information obtained during the first, second, and third interviews; and (x) displaying, via the user interface, a fourth questionnaire including a fourth self-evaluation and receiving, via the user interface, one or more answers to the fourth questionnaire.

These as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIG. 1 is a flow chart of a method according to an example embodiment.

FIG. 2 is a flow chart of another method according to an example embodiment.

FIG. 3A is a first page of a script of a first interview with a simulated patient according to an example embodiment.

FIG. 3B is a second page of the script of the first interview with the simulated patient according to an example embodiment.

FIG. 3C is a script of a second interview with a simulated patient according to an example embodiment.

FIG. 4A is a first page of an example self-evaluation questionnaire according to an example embodiment.

FIG. 4B is a second page of the example self-evaluation questionnaire according to an example embodiment.

FIG. 4C is a third page of the example self-evaluation questionnaire according to an example embodiment.

FIG. 5 is a computing device according to an example embodiment.

### DETAILED DESCRIPTION

### I. Overview

As noted above, a health professional may increase patient safety, reduce risk, and improve patient outcomes by embodying a number of skills including values of morality, altruism, and humanism, understanding roles and responsibilities within a patient care team, and communication, cooperation, and citizenship required for effective teamwork. These basic skills have been defined as the four Interprofessional Education Collaborative (IPEC) core competencies including (i) values and ethics for interprofessional practice, (ii) roles and responsibilities, (iii) interprofessional communication, and (iv) teams and teamwork. The four IPEC competencies are explained in more detail in INTERPROFESSIONAL EDUCATION COLLABORATIVE, CORE COMPETENCIES FOR INTERPROFESSIONAL COLLABORATIVE PRACTICE: REPORT OF AN EXPERT PANEL (May 2011), which is hereby incorporated by reference in its entirety.

The methods and systems described herein are designed to provide an educational model for enhancing a student's or health professional's learning and understanding of the IPEC core competencies. The student may be a student of one of various health fields such as a student of a medical school, dental school, pharmacy school, physical therapy school, physician assistant school, pathologist assistant school, nursing school, or psychology school. Similarly, the health professional may be a professional practicing in one of various health fields such as medicine, dentistry, pharmacology, physical therapy, pathology, nursing, or psychology. Other examples are possible as well.

The educational model may include the student or health professional observing and/or participating in a series of interviews with a simulated patient and creating a plan of care for the patient based on those interviews. Before and/or after each interview, the student or health professional may conduct a self-evaluation by answering various questions of a questionnaire. The questions may be chosen such that the student or health professional may be evaluated on their proficiencies of the four IPEC competencies. For instance, based on the student's or health professional's answers to the questionnaire, an instructor or some other evaluator may provide one or more evaluations of their proficiency in each of the four IPEC competencies. The evaluations may include written or verbal feedback and/or a letter grade or the like. The evaluations may be provided after the completion of each questionnaire or alternatively after the completion of all of the questionnaires.

### II. Example Methods and Systems

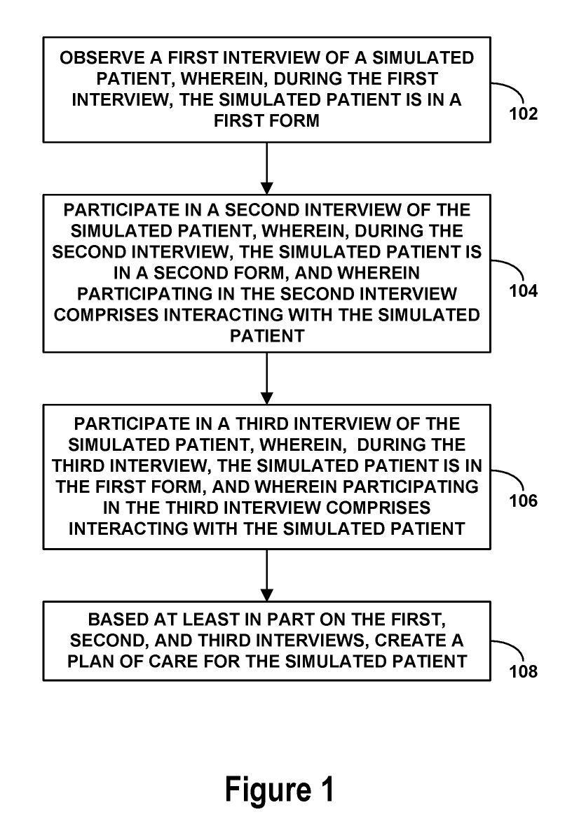

FIG. 1 is a flow chart of an example method. At block 102, the method may include a student or health professional observing a first interview of a simulated patient, wherein, during the first interview, the simulated patient is in a first form, such as in the form of a real or live person. The real person could be an actor that is provided with a script and/or with various background details of the simulated patient.

When observing the interview, the student or health professional may merely observe without interacting with the simulated patient. As such, the interview may be carried out by a facilitator, such as an instructor or another scripted actor, who asks questions to the simulated patient for observation by the student or health professional.

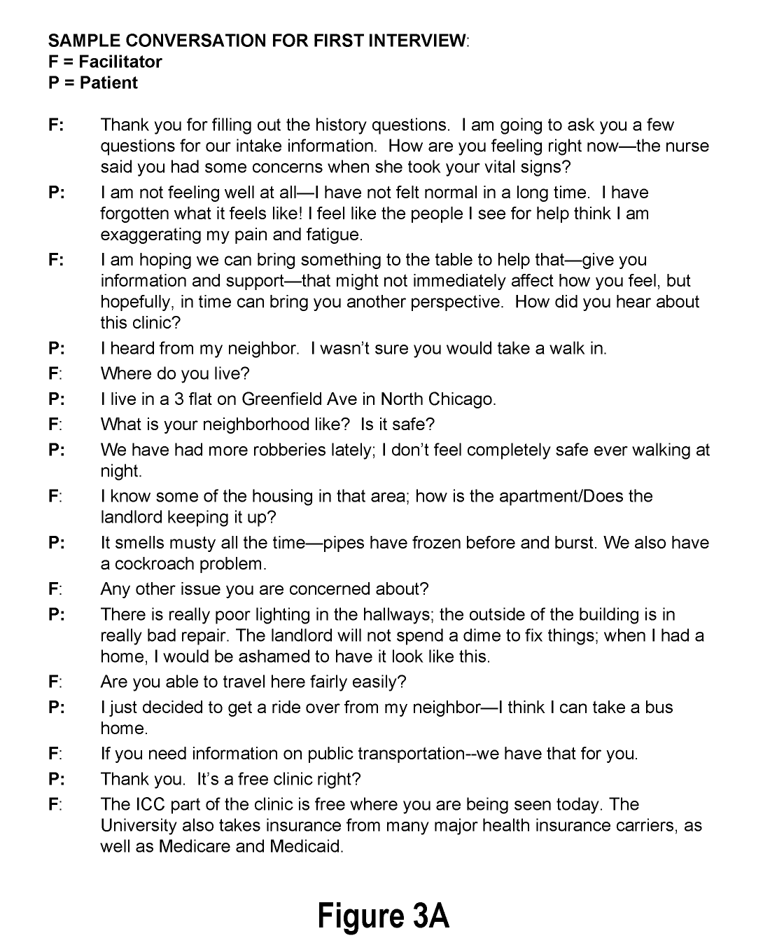

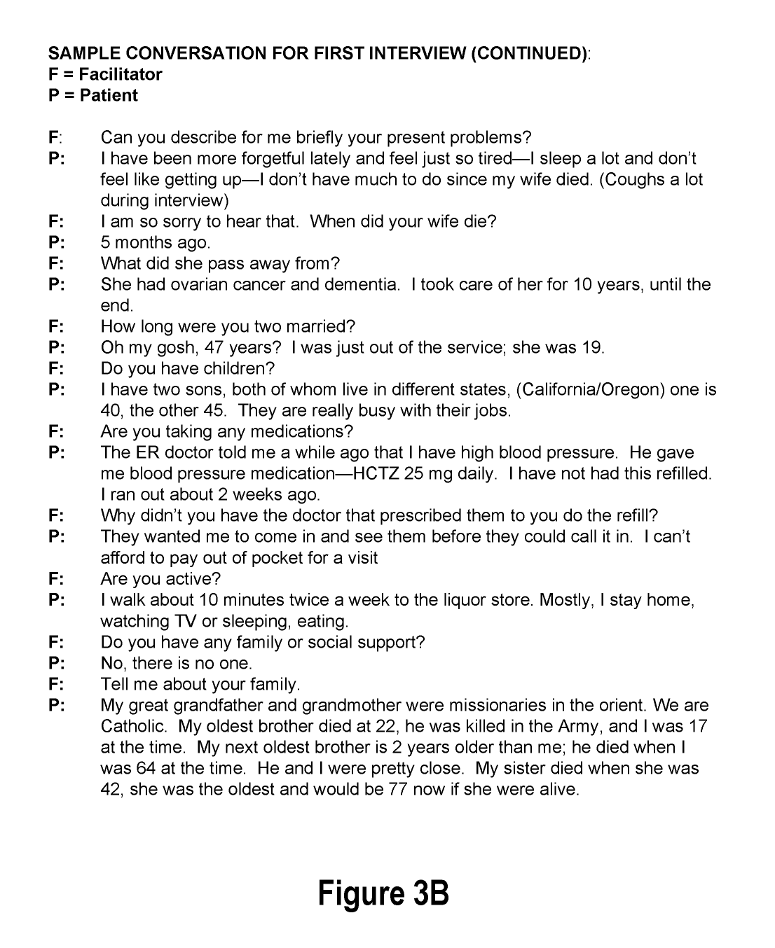

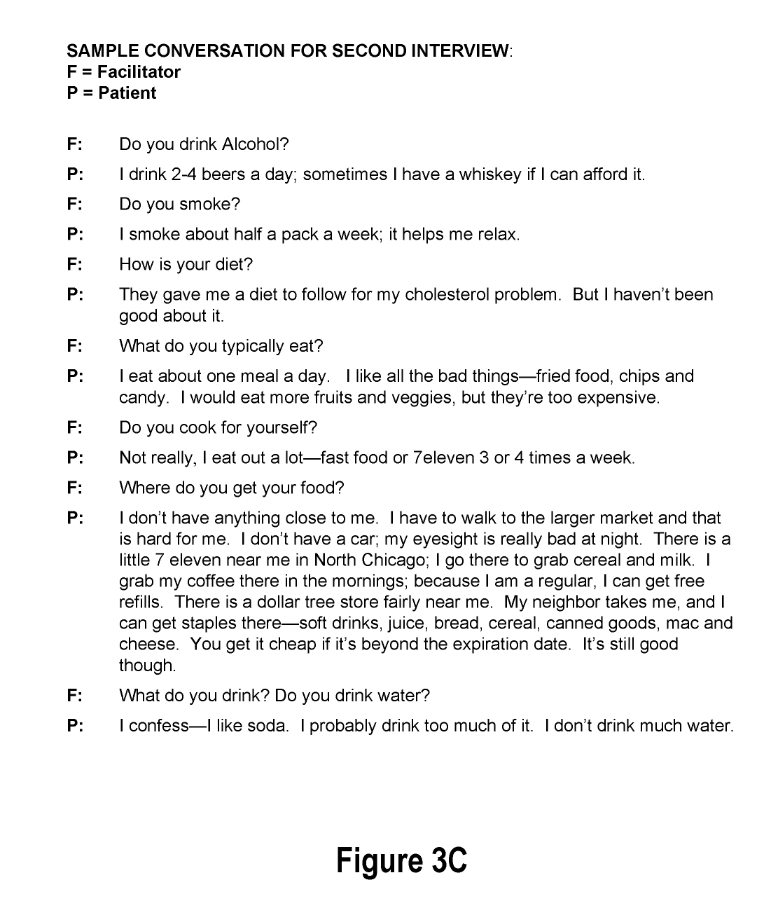

In some examples, the substance of the first interview may focus on a family history and environmental history of the simulated patient. FIGS. 3A and 3B illustrate an example script that may be used for the first interview. Based on answers provided by the simulated patient, the student or health professional may then create a family map for the simulated patient. The student or professional may do this as an individual or in cooperation with other students or health professionals. The family map may include information related to characteristics of the simulated patient's home, the simulated patient's neighborhood and larger community, and the geographical mobility of the simulated patient's family. In practice, for instance, the family map may include a family genogram and/or a family ecomap.

At block 104, the method may include the student or health professional participating in a second interview of the simulated patient, wherein, during the second interview, the simulated patient is in a second form that is different from the first form. For instance, rather than being a real person, the simulated patient could take the form of a mechanical dummy, mannequin, or the like.

When participating in the second interview, the student or health professional may interact with the simulated patient rather than merely observing. As such, the student or health professional may submit various questions or inquiries to the simulated patient to obtain information about the patient. Because the simulated patient is not a real person in this example, the simulated patient may be remotely controlled to answer the questions posed by the student or health professional. For instance, the facilitator or some other person, such as the person who portrayed the patient during the first interview, may be located remotely (e.g., in an adjacent room) from the simulated patient. In some examples, the student or health professional may provide questions to the remotely located person via a remote audio system. For example, the questions may be spoken into a microphone (e.g., a microphone disposed on or near the simulated patient) that is connected wirelessly or via a wired connection to a speaker near the remotely located person. Similarly, the remotely located person may provide answers to the questions by speaking the answers into a microphone that is connected to a speaker disposed on or near the simulated patient. In this manner, the student or health professional can participate in an interview with a patient without engaging in any direct human contact with the patient.

In some examples, the substance of the second interview may focus on aspects of the simulated patient's environment and community. For instance, before the student or health professional interacts with the patient, the facilitator may interview the patient by asking questions such as those shown in the example script of FIG. 3C.

In addition to participating in the second interview to obtain information about the patient's environment and community, the student or health professional may conduct outside research, using the Internet for example, to obtain further information about the demographics and environment of the patient's community. The student or health professional can then reflect as an individual and/or discuss as a group with other students or health professionals to determine the impact that any obtained information may have on the patient's health and recovery.

At block 106, the method may include the student or health professional participating in a third interview of the simulated patient, wherein, during the third interview, the simulated patient is in the first form, and wherein participating in the third interview comprises interacting with the simulated patient. For instance, the patient may again take the form of a real person, and the interview could include the facilitator or some other person leading the interview. In particular, the facilitator and the simulated patient may be located remotely (e.g., in another room), and the student or health professional may observe the interview via a computing system displaying a live or delayed video and audio feed (e.g., a computing system executing IP-based video call software or the like).

Additionally, rather than merely observing the third interview, the student or health professional could ask the simulated patient various questions. For instance, the student or health professional could speak to the remotely located simulated patient via the computing system facilitating the video call. As such, the student or health professional may again participate in the interview of the patient without engaging in any direct human contact with the patient.

The simulated patient could be trained to steer the conversation of the third interview to focus on the socioeconomic status of the patient. For example, the simulated patient could indicate that he or she has concerns about paying for or obtaining medication, getting to and from appointments, living conditions, neighborhood safety, depression, lack of a support system, and the like.

At block 108, the method may include the student or health professional creating a plan of care for the simulated patient based at least in part on the first, second, and third interviews. For instance, the student or health professional may use any information obtained from the interviews of the simulated patient, from researching the demographics or community of the simulated patient, or from discussions with other students or health professionals. The created plan of care may include recommendations of external services for the simulated patient in terms of the patient's specific social determinants of health. Examples may include counseling, housing, social support groups, or the like. Further, the external services may be specific to the neighborhood of the simulated patient. For instance, during the interviews of the simulated patient, the student or health professional may ascertain the patient's neighborhood and may thus include recommendations for specific external services that are available in the patient's neighborhood.

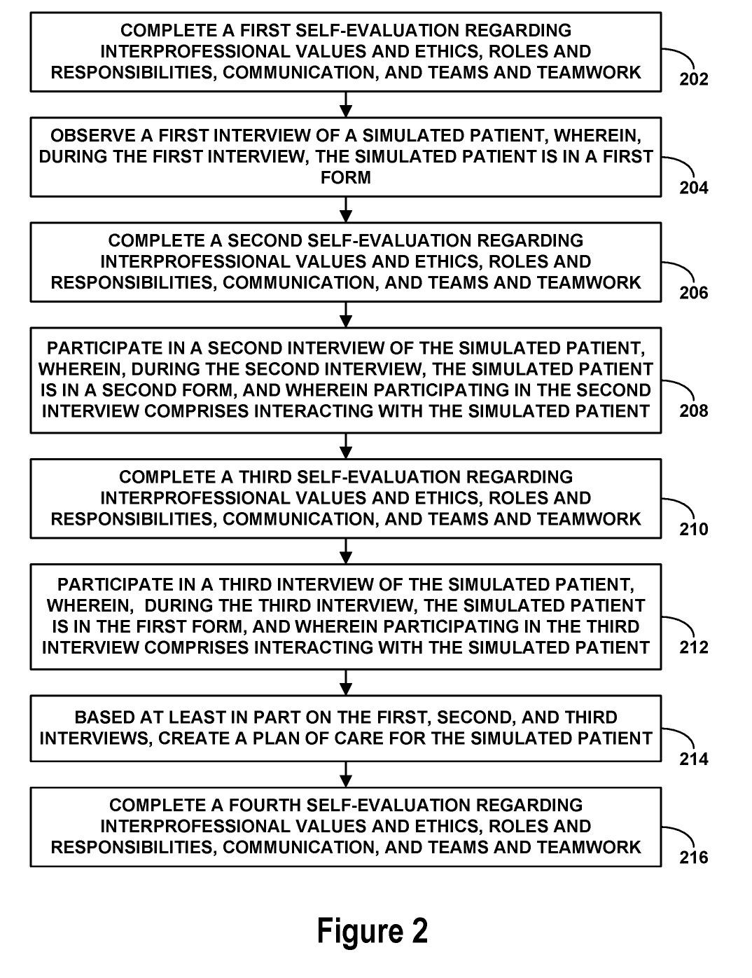

FIG. 2 is a flow chart of another example method. The example method of FIG. 2 is similar to the example method of FIG. 1, except the example method of FIG. 2 further includes evaluating the student or health professional to determine their proficiency in each of the four IPEC core competencies.

At block 202, the method may include the student or health professional completing a self-evaluation regarding the core IPEC competencies—interprofessional values and ethics, roles and responsibilities, communication, and teams and teamwork. This evaluation may be referred to as the Stage One evaluation, which may be used to establish a baseline measurement of the student's or health professional's proficiencies in the IPEC competencies.

Because the Stage One evaluation is a preliminary evaluation, the student or health professional may not be expected to demonstrate proficiency in each of the IPEC competencies. For instance, at the time of the Stage One evaluation, the student or health professional may be merely expected to exhibit a basic understanding of the IPEC competencies. As such, the Stage One evaluation may act as a benchmark to provide concrete information, activate a background knowledge of the student or health professional, explain the educational model disclosed herein, and provide the student or health professional with expectations for the outcome of the educational model.

The Stage One evaluation may include providing the student of health professional with a self-evaluation questionnaire. The questionnaire may include questions for evaluating the student's or health professional's views on interprofessional values and ethics (e.g., morality, altruism, and humanism). Such questions may include questions for determining the student's or health professional's proclivity to comply with established rules, respect authority, or respect the concerns, needs, feelings, or privacy of others, and/or for determining the student's or health professional's societal views. Other types of questions for evaluating interprofessional values and ethics may be included as well.

The Stage One evaluation may further include questions for evaluating the student's or health professional's views on interprofessional roles and responsibilities. Such questions may include questions for measuring the awareness and acceptance of similarities and differences among people such as similarities and differences based on nationality, race, culture, disability, or beliefs. Other types of questions for evaluating interprofessional roles and responsibilities may be included as well.

The Stage One evaluation may further include questions for evaluating the student's or health professional's views on interprofessional teams and teamwork. Such questions may include questions for determining the student's or health professional's proclivity to seek conflict, value cooperation over competition, work alone or in a group, support other group members, and/or socialize with others. Other types of questions for evaluating interprofessional communication may be included as well.

In addition to providing questions to evaluate the student's and health professional's views on interprofessional values and ethics, roles and responsibilities, and teams and teamwork, the Stage One evaluation may further evaluate the student's or health professional's interprofessional communication skills. Such an evaluation may be performed by observing how the student or health professional interacts with others when performing the various steps of the method discussed herein.

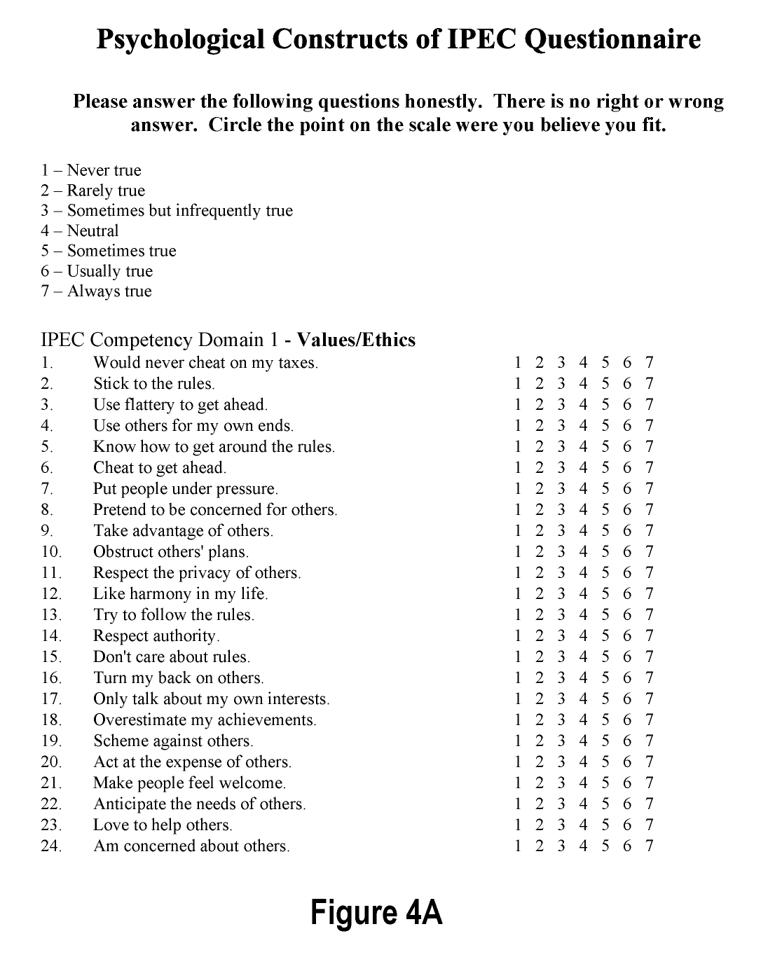

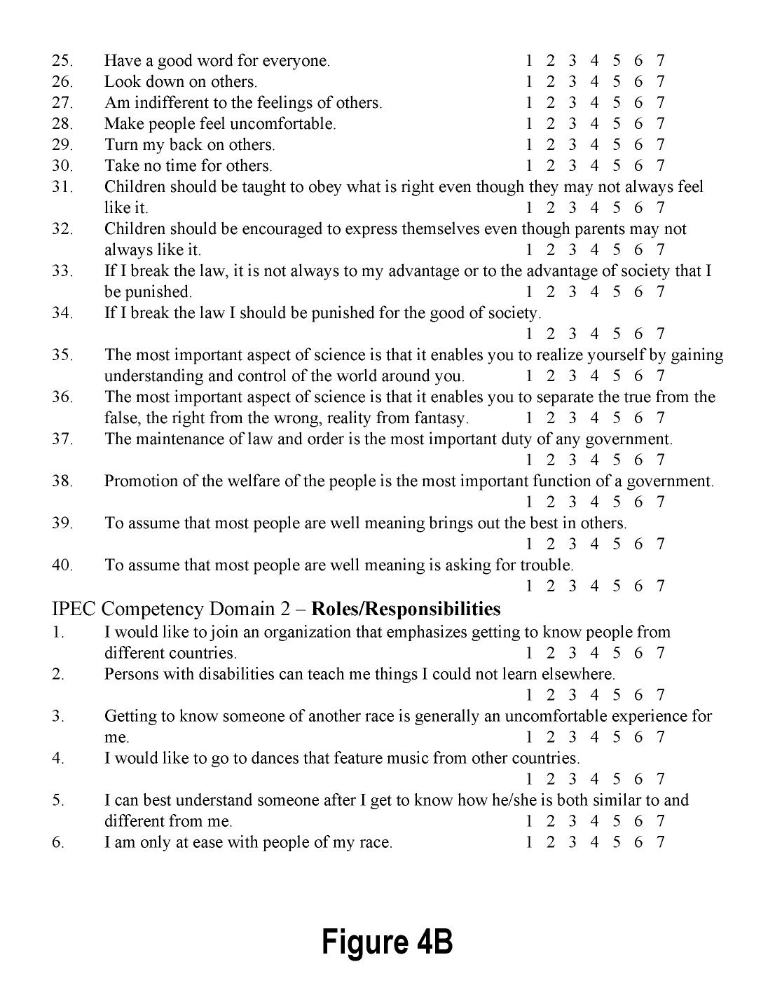

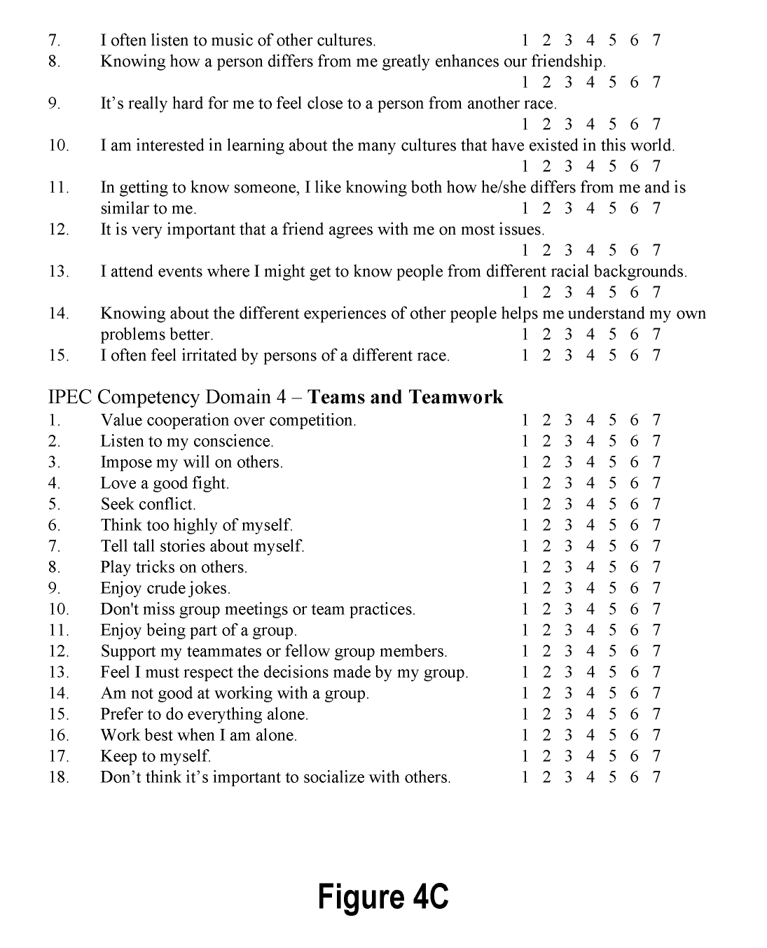

FIGS. 4A, 4B, and 4C depict various pages of an example questionnaire that may be provided as part of the Stage One evaluation. FIGS. 4A and 4B show example questions related to interprofessional values and ethics; FIGS. 4B and 4C show example questions related to interprofessional roles and responsibilities; and FIG. 4C shows example questions related to interprofessional teams and teamwork. In some examples, the questionnaire could further include questions related to interprofessional communication, or, as noted above, an evaluation of the student's or health professional's interprofessional communication skills may be performed through observation during execution of the educational model.

Referring back to FIG. 2, at block 204, after completing the Stage One evaluation, the method may include observing a first interview of a simulated patient, which may be carried out in the same or similar manner as described above with reference to block 102 of FIG. 1.

At block 206, the method may include the student or health professional completing a second self-evaluation regarding the core IPEC competencies. This evaluation may be referred to as the Stage Two evaluation. The Stage Two evaluation may be designed to evaluate the student or health professional on the same or similar subjects as the Stage One evaluation and may include the same or similar questions (e.g., the questions depicted in FIGS. 4A-4C) and evaluation techniques as the Stage One evaluation. However, the Stage Two evaluation may hold the student or health professional to a higher standard than the Stage One evaluation. As such, the Stage One evaluation may act as a milestone for the student or health professional to encourage reflection, refine knowledge, identify communication techniques, identify concepts, and provide feedback.

At block 208, after completing the Stage Two evaluation, the method may include participating in a second interview of the simulated patient, which may be carried out in the same or similar manner as described above with reference to block 104 of FIG. 1.

At block 210, the method may include the student or health professional completing a third self-evaluation regarding the core IPEC competencies. This evaluation may be referred to as the Stage Three evaluation. The Stage Three evaluation may be designed to evaluate the student or health professional on the same or similar subjects as the Stage One and Two evaluations and may include the same or similar questions (e.g., the questions depicted in FIGS. 4A-4C) and evaluation techniques as the Stage One and Two evaluations. However, the Stage Three evaluation may hold the student or health professional to a higher standard than the previous evaluations. As such, the Stage Three evaluation may act as a milestone for the student or health professional to consolidate and assess knowledge and comprehension, encourage conceptualization, develop critical thinking skills, develop plans and strategies, and assess the developed plans and strategies.

At block 212, after completing the Stage Three evaluation, the method may include participating in a third interview of the simulated patient, which may be carried out in the same or similar manner as described above with reference to block 106 of FIG. 1. And at block 214, the method may include creating a plan of care for the simulated patient based at least in part on the first, second, and third interviews, which may be carried out in the same or similar manner as described above with reference to block 108 of FIG. 1.

At block 216, the method may include the student or health professional completing a fourth self-evaluation regarding the core IPEC competencies. This evaluation may be referred to as the Stage Four evaluation. The Stage Four evaluation may be designed to evaluate the student or health professional on the same or similar subjects as the Stage One, Two, and Three evaluations (e.g., using the questions depicted in FIGS. 4A-4C). The Stage Four evaluation may additionally include an evaluation of the created plan of care to determine the extent to which the plan of care demonstrates proficiencies in the IPEC core competencies. Further, the Stage Four evaluation may hold the student or health professional to a higher standard than the previous evaluations. As such, the Stage Four evaluation may act as a capstone to encourage synthesis of knowledge and information, encourage application of knowledge, assess the application of knowledge, and assess the plan implementation and result. The Stage Four evaluation may be carried out as an evaluation by an instructor and/or as a self-evaluation by the student or health professional.

During each of the Stage One, Two, Three, and Four evaluations, the student or health professional may be evaluated in various ways to determine their proficiency in the IPEC core competencies. For instance, in evaluations where the student or health professional completes a self-evaluation questionnaire, the student or health professional can be evaluated by applying a rubric to the completed questionnaire. Examples of such rubrics are included below in Tables 1-4 of the Appendix section.

As noted above and as demonstrated by the example rubrics, each subsequent stage of the evaluations holds the student or health professional to a higher standard. For instance, referring to the rubric of Table 4, a student or health professional may be evaluated in each stage on their ability to “demonstrate high standards of ethical conduct and quality of care in contributions to team-based care.” Specifically, in order to meet expectations of the Stage One evaluation, the student or health professional may be expected to “recognize ethical issues when presented in a complex, multi-layered context as well as cross-relationships among the issues.” In order to meet expectations of the Stage Two evaluation, the student or health professional may further be expected to “discuss how ethical issues may influence quality of team-based care.” In order to meet expectations of the Stage Three evaluation, the student or health professional may further be expected to “create best practices to influence and promote high quality team-based care.” And in order to meet expectations of the Stage Four evaluation, the student or health professional may further be expected to “apply, evaluate, and reassess best ethical practices within a patient's plan of care.” Other examples are also illustrated by the example rubrics in Tables 1-4.

In practice, the rubric in Table 1 may be applied during the Stage One evaluation, the rubric in Table 2 may be applied during the Stage Two evaluation, the rubric in Table 3 may be applied during the Stage Three evaluation, and the rubric in Table 4 may be applied during the Stage Four evaluation. In other examples, the evaluations of each of the stages may involve using more than one of the example rubrics, using metrics from multiple different example rubrics, and/or using metrics that are not shown by the example rubrics.

As noted above, the student or health professional may be provided with feedback regarding the Stage One, Two, Three, and Four evaluations at various times. For instance, the student or health professional could be provided with feedback after each individual evaluation or after the completion of all of the evaluations. The feedback may include an indication of whether each rubric metric has been satisfied for a particular stage. The feedback may include written or verbal feedback of how the student or health professional may improve. And in some examples, the feedback may include a letter or percentage grade based on how many rubric metrics were satisfied by the student or health professional. Further, if a student or health professional does not satisfy a sufficient number of metrics for a given stage evaluation, the student or health professional may be required to repeat one or more prior steps of the educational model before advancing to the next step. For instance, if the Stage Two evaluation indicates low proficiency by the student or health professional, then the student or health professional may be required to repeat the observation of the first interview before participating in the second interview. Other examples are possible as well.

By carrying out the methods disclosed herein, the student or health professional may become more aware and have a better understanding of interprofessional education and the IPEC competencies. This may help the student or health professional better understand and explore how the social determinants of health can affect patient health and outcomes, especially as related to underserved populations.

In some examples, some parts or all of the methods disclosed herein may be carried out by one or more computing devices. For instance, the first interview could be a pre-recorded interview or a live video feed of the interview displayed on a user interface of the computing device. The student or health professional could thus observe the first interview via the user interface of the computing device.

Similarly, the computing device may further facilitate the student's or health professional's participation in the second interview. For instance, the simulated patient may take the form of a virtual avatar displayed on the user interface of the computing device. The student or health professional may thus provide inquiries to the virtual avatar via the user interface of the computing device. For example, the student or health professional may input an inquiry via a keyboard or mouse input. Alternatively or additionally, the inquiries may be spoken into a microphone of the computing device and transmitted as audio or converted to text using voice-to-text software. The inquiries may then be transmitted over a network, such as the Internet to a remote computing device. And an operator of the remote computing device may provide answers to the inquiries in a similar manner (e.g., using voice or text input).

The computing device may also facilitate the student's or health professional's participation in the third interview. For instance, like the first interview, the third interview could be a pre-recorded interview or a live video feed of the interview displayed on a user interface of the computing device, thereby allowing the student or health professional to observe the third interview via the user interface of the computing device. Further, like the second interview, during the third interview the computing device could be configured to receive various inquiries from the student or health professional as well as provide answers to the inquiries via the user interface of the computing device.

Additionally, the computing device may facilitate some or all of the evaluations. For instance, for any or all of the Stage One, Two, Three, or Four evaluations, the computing device may display a questionnaire via the user interface of the computing device. The student or health professional may then perform a self-evaluation by inputting answers to the questionnaire via the user interface (e.g., using a keyboard or mouse).

Similarly, the computing device may facilitate completion of the plan of care for the simulated patient. For instance, the student or health professional may input their created plan of care into the user interface of the computing device, and the plan of care may then be transmitted via a network to a remote computing device. An operator of the remote computing device, such as an instructor, may receive the plan of care and input an evaluation of the plan of care into the remote computing device. The remote computing device may then transmit the evaluation back to the computing device for display to the student or health professional via the user interface of the computing device.

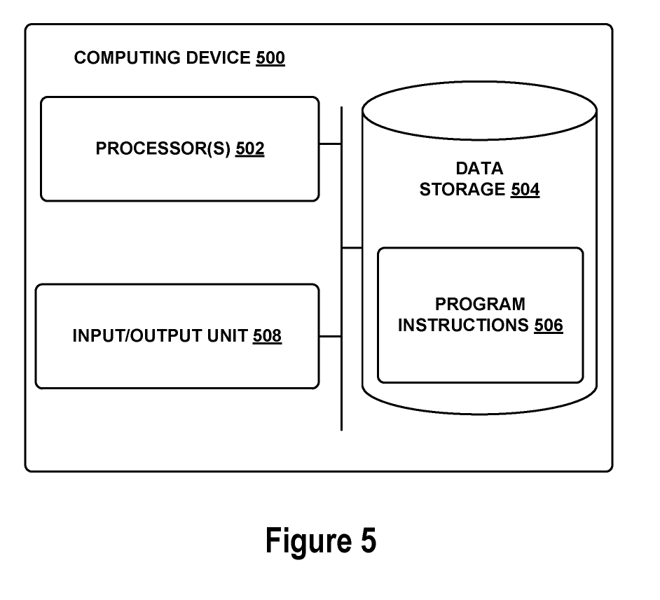

FIG. 5 illustrates an example computing device 500 for carrying out various methods, processes, or functions disclosed herein. The computing device 500 can include one or more processors 502, data storage 504, program instructions 506, and an input/output unit 508, all of which can be coupled by a system bus or a similar mechanism. The one or more processors 502 can include one or more central processing units (CPUs), such as one or more general purpose processors and/or one or more dedicated processors (e.g., application specific integrated circuits (ASICs) or digital signal processors (DSPs), etc.).

The data storage 504 can include or take the form of one or more computer-readable storage media that can be read or accessed by at least one of the one or more processors 502. The one or more computer-readable storage media can include volatile and/or non-volatile storage components, such as optical, magnetic, organic, or other memory or disc storage, which can be integrated in whole or in part with at least one of the one or more processors 502. In some embodiments, the data storage 504 can be implemented using a single physical device (e.g., one optical, magnetic, organic, or other memory or disc storage unit), while in other embodiments, the data storage 504 can be implemented using two or more physical devices.

The input/output unit 508 can include user input/output devices, network input/output devices, and/or other types of input/output devices. For example, input/output unit 508 can include user input/output devices, such as a touch screen, a keyboard, a keypad, a computer mouse, liquid crystal displays (LCD), light emitting diodes (LEDs), displays using digital light processing (DLP) technology, cathode ray tubes (CRT), light bulbs, and/or other similar devices. Network input/output devices can include wired network receivers and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, and/or wireless network receivers and/or transceivers, such as a Bluetooth transceiver, a Zigbee transceiver, a Wi-Fi transceiver, a WiMAX transceiver, a wireless wide-area network (WWAN) transceiver and/or other similar types of wireless transceivers configurable to communicate via a wireless network.

In practice, the one or more processors 502 can be configured to execute computer-readable program instructions 506 that are stored in the data storage 504 and are executable to provide at least part of the functionality described herein. For instance, the one or more processors 502 may be configured to execute the computer-readable program instructions 506 in order to (i) display, via the input/output unit 504, a first interview of a simulated patient, wherein, during the first interview, the simulated patient is displayed in a first form; (ii) display, via the input/output unit 504, a second interview of the simulated patient, wherein, during the second interview, the simulated patient is displayed in a second form; (iii) during the second interview, receive, via the input/output unit 504, one or more inquiries for the simulated patient and output, via the input/output unit 504, one or more responses to the one or more inquiries; (iv) display, via the input/output unit 504, a third interview of the simulated patient, wherein, during the third interview, the simulated patient is displayed in the first form; (v) during the third interview, receive, via the input/output unit 504, one or more inquiries for the simulated patient and output, via the input/output unit 504, one or more responses to the one or more inquiries; and (vi) receive, via the input/output unit 504, a plan of care for the simulated patient, wherein the plan of care is based at least in part on the first, second, and third interviews.

The computing device 500 can be implemented in whole or in part in various devices, such as a smartphone, smartwatch, tablet, laptop, or personal computer. Generally, the manner in which the computing device 500 is implemented can vary, depending upon the particular application.

### III. Conclusion

The particular arrangements shown in the Figures should not be viewed as limiting. It should be understood that other embodiments can include more or less of each element shown in a given Figure. Further, some of the illustrated elements can be combined or omitted. Yet further, an exemplary embodiment can include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the claims. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

### IV. Appendix

TABLE 1

| | Capstone | Milestone 2 | Milestone 1 | Benchmark |
|---|---|---|---|---|
| | Learning Stage Four | Learning Stage Three | Learning Stage Two | Learning Stage One |
| | Encourage synthesis | Consolidate and assess | Encourage reflection | Provide concrete information |
| | of knowledge and information | knowledge & | Refine knowledge | Activate background |
| | Apply of knowledge | comprehension | Identify communication | knowledge |
| | Assess knowledge application | Encourage conceptualization | techniques | Explain model |
| | Assess plan implementation | Develop Critical | Identify concepts | Provide expectations |
| | and result | thinking skills | Provide feedback | |
| | | Develop strategies/ | | |
| | | plan | | |
| | | Assess strategy | | |
| Describe the process | Develop an Interprofessional | Evaluate and identify | Interacts effectively with | Identify roles, responsibilities |
| of team development | plan of care to | resources, roles and | team members to identify | and practices of |
| and the roles and | increase patient out- | responsibilities to provide | health concerns of the | effective teams. |
| practices of effective | comes and quality of | quality of care. | patient. | |
| teams. | care. | | | |
| Develop consensus on | Supports a constructive | Supports a constructive | Supports a constructive | Supports a constructive |
| the ethical principles | team climate by | team | team | team climate by |
| to guide all aspects | doing all of the following: | climate by doing | climate by doing | doing any one of the |
| of teamwork. | Treats team members | any three of the | any two of the | following: |
| | respectfully by being | following: | following: | Treats team members |
| | polite and constructive | Treats team members | Treats team members | respectfully by being |
| | in communication. | respectfully by being | respectfully by being | polite and constructive |
| | Uses positive vocal or | polite and constructive | polite and constructive | in communication. |
| | written tone, facial | in communication. | in communication. | Uses positive vocal or |
| | expressions, and/or body | Uses positive vocal or | Uses positive vocal or | written tone, facial |
| | language to convey a | written tone, facial | written tone, facial expressions, | expressions, and/or body |
| | positive attitude about | expressions, and/or body | and/or body | language to convey a |
| | the team and its work. | language to convey a | language to convey a | positive attitude about |
| | Motivates teammates | positive attitude about | positive attitude about | the team and its work. |
| | by expressing | the team and its work. | the team and its work. | Motivates teammates |
| | confidence about the | Motivates teammates | Motivates teammates | by expressing |
| | importance of the task | by expressing | by expressing | confidence about the |
| | and the team's ability | confidence about the | confidence about the | importance of the task |
| | to accomplish it. | importance of the task | importance of the task | and the team's ability |
| | Provides assistance | and the team's ability | and the team's ability | to accomplish it. |
| | and/or encouragement | to accomplish it. | to accomplish it. | Provides assistance |
| | to team members. | Provides assistance | Provides assistance | and/or encouragement |
| | | and/or encouragement | and/or encouragement | to team members. |
| | | to | to team members. | |
| | | team members. | | |
| Choose effective | Implement communications | Evaluate impact of | Communicates effectively | Identify valid tools, |
| communication tools | tools and resources | chosen communication | with team members | techniques, and practices |
| and techniques, | within an Interprofessional | tools on ability of team | to choose appropriate | of effective |
| including information | plan of | to provide quality of | communication | communication that |
| systems and | care to increase patient | care. | tools to identify health | facilitate and enhance |
| communication | outcomes and quality | | concerns of the patient. | team function. |
| technologies, to | of care. | | | |
| facilitate discussions | | | | |
| and interactions that | | | | |
| enhance team function. | | | | |
| Communicate | Reflect on individual | Reflect on language | Identify and describe | Identify and analyze |
| information with | and team performance | needed to be improved | language that that result | current language used |
| patients, families, | and how language and | and create a plan for | in excellence of | between team members, |
| community members, | communication tools | improvement. | individual and team | community |
| and health team | result in improved patient | | performance and those | members, family and |
| members in a form | outcomes and | | behaviors that need to | patient. |
| that is understandable, | quality of care. | | be improved. | |
| avoiding discipline- | | | | |
| specific terminology | | | | |
| when possible. | | | | |
| Communicate one's | Evaluate effectiveness | Implementing effective | Identifies and | Identify and reflect on |
| roles and | of roles and responsibilities | strategies | acknowledge how | the roles and responsibilities |
| responsibilities clearly | between other | communicate | roles and responsibilities | of individuals |
| to patients, families, | professionals, patients, | roles and responsibilities | of individuals | and teams to communicate |
| community members, | families, and community | between | and teams | with other |
| and other | members. | other professionals, | are communicated | professionals, patients, |
| professionals. | | patients, families, | with other professionals, | families and community |
| | | and community | patients, | members. |
| | | members. | families, community | |
| | | | members. | |
| Place interests of | Assess and evaluate | Develop focused | Determine that | Identify health concerns, |
| patients and | the plan of care or | plan of care or | the patient or | barriers and plan |
| populations at | health policy. | health policy. | population is the | of care of the patient or |
| center of | | | focus of the plan | population, taking into |
| interprofessional | | | of care or health | consideration family, |
| health care delivery | | | policy. | community and environmental |
| and population | | | | factors. |
| health programs | | | | |
| and policies, with | | | | |
| the goal of promoting | | | | |
| health and health | | | | |
| equity across | | | | |
| the life span. | | | | |

TABLE 2

| | Capstone | Milestone 2 | Milestone 1 | Benchmark |
|---|---|---|---|---|
| | Learning Stage Four | Learning Stage Three | Learning Stage Two | Learning Stage One |
| | Encourage synthesis | Consolidate and assess | Encourage reflection | Provide concrete information |
| | of knowledge and information | knowledge & | Refine knowledge | Activate background |
| | Apply of knowledge | comprehension | Identify communication | knowledge |
| | Assess knowledge application | Encourage conceptualization | techniques | Explain model |
| | Assess plan implementation | Develop Critical | Identify concepts | Provide expectations |
| | and result | thinking skills | Provide feedback | |
| | | Develop strategies/ | | |
| | | plan | | |
| | | Assess strategy | | |
| Engage health and | Develop an effective | Identify resources needed | Engages team members | Identify concerns of patient |
| other professionals in | plan of care considering | for effect plan of | in ways that facilitate | and the cultural, |
| shared patient- | the whole patient and | care. Engages team | their contributions to | familial and social environment |
| centered and | patient's environment. | members in ways that | meetings by constructively | and influences |
| population-focused | | facilitate their contributions | building upon or | surrounding the patient. |
| problem-solving. | | to meetings by both | synthesizing the contributions | |
| | | constructively building | of others in order | |
| | | upon and synthesizing | to initiate problem | |
| | | the contributions of others | solving. | |
| | | as well as noticing | | |
| | | when someone is not | | |
| | | participating and inviting | | |
| | | them to engage. | | |
| Integrate the | Interprofessional team | Interprofessional team | Engage team members | Identify the environmental |
| knowledge and | integrates patient and | identifies resources to | in discussing patient | influences on the patient |
| experience of health | community values, priorities | patient and community | concerns in context of | that influence care |
| and other professions | and preferences | values, priorities and | their environment and | and roles of the Interprofessional |
| to inform health | into plan of care. | preferences | community values. | team in providing |
| and care | | | | care. |
| decisions, while | | | | |
| respecting patient and | | | | |
| community values and | | | | |
| priorities/preferences | | | | |
| for care. | | | | |
| Express one's | Practice and evaluate | Reflect on communication | Discuss communication | Identify and evaluate |
| knowledge and | respectful, polite and | to be improved and | needs and preferences | respectful, polite and |
| opinions to team | constructive communication | create a plan for improvement | of team for effective | constructive communication |
| members involved | between team | of team efficacy | Interprofessional | between team |
| in patient care and | members and its impact | | care. | members. |
| population health | on Interprofessional | | | |
| improvement with | patient care. | | | |
| confidence, clarity, | | | | |
| and respect, | | | | |
| working to ensure | | | | |
| common | | | | |
| understanding | | | | |
| of information, | | | | |
| treatment, care | | | | |
| decisions, and | | | | |
| population | | | | |
| health programs | | | | |
| and policies. | | | | |
| Listen actively, and | Practice and evaluate | Reflect on communication | Discuss and evaluate | Identify delivery techniques |
| encourage ideas and | communication behaviors | behaviors to be improved | communication behavioral | (posture, gesture, |
| opinions of other team | among team | and create a plan | needs and preferences | eye contact, and vocal |
| members. | members and their impact | for improvement of team | of team for effective | expressiveness) that detract |
| | on Interprofessional | efficacy | Interprofessional | and promote ideas |
| | patient care. | | care. | and opinions of other |
| | | | | team members. |
| Recognize one's | Develop and | Evaluate and | Reflect on how one's | Identify the limitations |
| limitations in skills, | compile an individual | identify individual | limitations effects the | of one's roles, responsibilities |
| knowledge, and | toolbox for | resources to facilitate | team's ability to identify | within a team. |
| abilities. | working within an | an individuals | and assess the health | |
| | Interprofessional | contribution | concerns of the patient. | |
| | team to increase | to team efficacy. | | |
| | patient outcomes | | | |
| | and quality of | | | |
| | care. | | | |
| Engage diverse | Implement and evaluate | Develop a plan of care | Reflect on one's own | Identify and describe |
| professionals who | the effectiveness of the | in collaboration with the | role and responsibility | professionals required to |
| complement one's | plan of care on the | identified Interprofessional | within the team and its | advance specific |
| own professional | healthcare needs of the | team. | impact on the specific | healthcare needs of patients. |
| expertise, as well as | patient. | | healthcare needs of the | |
| associated resources, | | | patient. | |
| to develop strategies | | | | |
| to meet specific health | | | | |
| and healthcare needs | | | | |
| of patients and | | | | |
| populations. | | | | |
| Embrace the cultural | Implement and | Develop a strategy | Resolve any identified | Research and understand |
| diversity and | evaluate the strategy | to address conflicts | conflicts between cultural | cultural diversity |
| individual differences | to favor patient | between cultural | diversity and individual | and individual differences |
| that characterize | outcomes | diversity and | differences | that characterize |
| patients, populations, | and quality of | individual differences | that characterize patients, | patients, populations, |
| and the health team. | care. | that characterize | populations, and | and the health team. |
| | | patients, | the health team with | |
| | | populations, and | respect to the plan of | |
| | | the health team | care. | |
| | | with respect to the | | |
| | | plan of care. | | |
| Respect the unique | Implement, evaluate | Compare and assess | Discuss and reflect | Identify team members' |
| cultures, values, | and improve | how team | how team members' | unique cultures, |
| roles/responsibilities, | how the unique | members' unique | unique cultures, values, | values, |
| and expertise of other | cultures, values, | cultures, values, | roles/responsibilities, | roles/responsibilities, |
| health professions and | roles/responsibilities, | roles/responsibilities, | and expertise and how | and expertise. |
| the impact these | and expertise | and expertise | the team can leverage | |
| factors can have | and how the team | and how the team | these unique aspect to | |
| on health outcomes. | can leverage these | can leverage these | promote healthcare and | |
| | unique aspect to | unique aspect to | prevents disease. | |
| | promote | Promote | | |
| | healthcare and | healthcare and | | |
| | prevents disease. | prevents disease. | | |

TABLE 3

| | Capstone | Milestone 2 | Milestone 1 | Benchmark |
|---|---|---|---|---|
| | Learning Stage Four | Learning Stage Three | Learning Stage Two | Learning Stage One |
| | Encourage synthesis | Consolidate and assess | Encourage reflection | Provide concrete information |
| | of knowledge and information | knowledge & | Refine knowledge | Activate background |
| | Apply of knowledge | comprehension | Identify communication | knowledge |
| | Assess knowledge application | Encourage conceptualization | techniques | Explain model |
| | Assess plan implementation | Develop Critical | Identify concepts | Provide expectations |
| | and result | thinking skills | Provide feedback | |
| | | Develop strategies/ | | |
| | | plan | | |
| | | Assess strategy | | |
| Apply leadership | Evidence that fluid | Practice change of leadership | Understand and practices | Identify roles, responsibilities |
| practices that support | leadership changes increase | roles with environmental | professional roles | and practices of |
| collaborative practice | patient outcomes | changes. | and limitation given | effective teams, while |
| and team | and quality of care. | | leadership responsibilities. | understanding that team |
| effectiveness. | | | | leadership changes with |
| | | | | concerns at hand. |
| Engage self and others | Addresses and evaluate | Identify and | Redirect focus of team | Identify and discuss current |
| to constructively | destructive conflict directly | acknowledge conflict | members, patients, family | and alternate view- |
| manage | and constructively, | between of team members, | and community members | points/ideas/opinions of |
| disagreements about | helping to manage/ | patients, family | toward common | team members, patients, |
| values, roles, goals, | resolve it in a way | and community members | ground and toward task | family and community |
| and actions that | that strengthens overall | and stays engaged | at hand (away from conflict). | members. |
| arise among health | team cohesiveness and | with it. | | |
| and other | future effectiveness of | | | |
| professionals and | patient outcomes and | | | |
| with patients, families, | quality of care. | | | |
| and community | | | | |
| members. | | | | |
| Give timely, sensitive, | Reflect on impact of | Develop and implement | Evaluate constructive, | Identify and discuss |
| instructive feedback to | feedback performance | best practices for providing | respectful feed back | feedback techniques for |
| others about their | individual and team | individual and team | techniques that result in | individual and team |
| performance on the | performance and how | feedback. | excellence of individual | performance. |
| team, responding | feedback results in | | and team performance | |
| respectfully as a team | improved patient | | and those techniques | |
| member to feedback | outcomes and quality | | that need to be improved. | |
| from others. | of care. | | | |
| Use respectful | Evaluate effectiveness of | Implementing effective | Identifies and acknowledges | Identify and reflect on |
| language appropriate | communication on patient | communication tools to | language barriers | current language used to |
| for a given difficult | outcomes and quality | overcome barriers between | between of team members, | communicate with team |
| situation, crucial | of care. | team members, | patients, family | members, patients, family |
| conversation, or | | patients, family and | and community members | and community members. |
| conflict. | | community members | and how these barrier | |
| | | toward common ground | may impact quality | |
| | | and toward improved | of care. | |
| | | quality of care. | | |
| Use the full scope of | Evaluate and assess the | Create a plan of care utilizing | Determine and evaluate | Identify knowledge, |
| knowledge, skills, and | effectiveness of the plan | The full score of | how each professional | skills, and abilities of the |
| abilities of | of care on the healthcare | each professional, | contributes knowledge, | team. |
| professionals from | needs of the patient. | | skills, and abilities to the | |
| health and other | | | team and to patient | |
| fields to provide | | | comes. | |
| care that is safe, | | | | |
| timely, efficient, | | | | |
| effective, and | | | | |
| equitable. | | | | |
| Communicate with | Reflect on improved | Implement improvement | Assess communication | Identify and discuss |
| team members to | communication processes | in communication processes | processes and policies | communication processes |
| clarify each member's | and procedures in executing | and policies and | for efficacy in executing | used by the team and |
| responsibility in | components of a | assess impact in executing | components of a treatment | each individual's responsibility |
| executing components | treatment plan or public | components of a | plan or public | in executing |
| of a treatment plan | health intervention and | treatment plan or public | health intervention. | components of a treatment |
| or public health | how these changes result | health intervention. | | plan or public |
| intervention. | in improved patient- | | | health intervention. |
| | centered care and population | | | |
| | health programs | | | |
| | and policies. | | | |
| Work in cooperation | Evaluate effectiveness of | Implement a plan of care | Assess resources and | Identify scope of practice |
| with those who receive | plan of care on improvement | incorporating all contributors | identify availability of | of all professionals, |
| care, those who | of patient | needed to advance | all professionals, and | and influences from |
| provide care, and | health. | patient health | family and community | family and community |
| others who contribute | | within plan of care | members and support | members who maybe |
| to or support the | | | services that maybe required | involved in developing a |
| delivery of prevention | | | to contribute to a | plan of care. |
| and health services | | | successful plan of care. | |
| and programs. | | | | |
| Develop a trusting | Evaluate and reassess | Develop an ongoing | Develop a communication | Identify the supportive |
| relationship with | communication strategies. | communication plan | strategy with key | environment surrounding |
| patients, families, | | with identified key players. | player within the patient's | the patient. |
| and other team | | | supportive community. | |
| members. | | | | |

TABLE 4

| | Capstone | Milestone 2 | Milestone 1 | Benchmark |
|---|---|---|---|---|
| | Learning Stage Four | Learning Stage Three | Learning Stage Two | Learning Stage One |
| | Encourage synthesis | Consolidate and assess | Encourage reflection | Provide concrete information |
| | of knowledge and information | knowledge & | Refine knowledge | Activate background |
| | Apply of knowledge | comprehension | Identify communication | knowledge |
| | Assess knowledge application | Encourage conceptualization | techniques | Explain model |
| | Assess plan implementation | Develop Critical | Identify concepts | Provide expectations |
| | and result | thinking skills | Provide feedback | |
| | | Develop strategies/ | | |
| | | plan | | |
| | | Assess strategy | | |
| Reflect on individual | Reflect on individual | Reflect on behaviors that | Identify and describe | Identify and discuss assessable |
| and team performance | and team performance | need to be improved and | behaviors that result in | parameters for |
| for individual, as well | and how parameters result | create a plan for | excellence of individual | individual and team performance. |
| as team, performance | in improved patient | improvement. | and team performance | |
| improvement. | outcomes and quality of | | and those behaviors that | |
| | care. | | need to be improved. | |
| Recognize how one's | Implement, evaluate and | Compare and assess behavior | Discuss and reflect as a | Identify one's unique |
| uniqueness (experience | improve individual behavior | of individuals on | team on individual | role contributes to effective |
| level, expertise, | and contribution | the effectiveness of the | contributions to team | communication, |
| culture, power, and | to the team that result in | team and best practices. | behavior and how | conflict resolution, and |
| hierarchy within | improved patient outcomes | | individuals support | positive interprofessional |
| the health team) | and quality of | | teamwork best practices. | working relationships. |
| contributes to | care. | | | |
| effective | | | | |
| communication, | | | | |
| conflict resolution, | | | | |
| and positive | | | | |
| interprofessional | | | | |
| working | | | | |
| relationships. | | | | |
| Forge interdependent | Evaluate effectiveness of | Develop a plan of care | Assess resources and | Identify scope of practice |
| relationships with | plan of care on improvement | incorporating all professions | identify availability of | of all professionals |
| other professions | of patient | identified as being | all professionals who | who maybe involved in |
| within and outside | health. | needed to advance patient | maybe involved in developing | developing a plan of |
| of the health | | health within plan | a plan of care. | care. |
| system to improve | | of care | | |
| care and advance | | | | |
| learning. | | | | |
| Engage in continuous | Develop and compile a | Evaluate and identify | Reflect on how other | Increase one's |
| professional and | team toolbox for increasing | other professionals' | professionals' scope of | knowledge of other |
| interprofessional | the performance | scope of practice, roles | practice, roles and | professionals' scope of |
| development to | and collaboration | and responsibilities that | responsibilities may increase | practice, roles and |
| enhance team | of an Interprofessional | may increase effectiveness | effectiveness of | responsibilities within an |
| performance and | team. | of an interprofessional | an interprofessional | interprofessional team. |
| collaboration. | | team performance | team performance and | |
| | | and collaboration. | collaboration. | |
| Demonstrate high | Apply, evaluate, and reassess | Create best practices to | Discuss how ethical issues | Recognize ethical issues |
| standards of ethical | best ethical practices | influence and promote | may influence quality | when presented in a |
| conduct and quality of | within a patient's | high quality team-based | of team-based care. | complex, multilayered |
| care in contributions to | plan of care. | care. | | (gray) context as well as |
| team-based care. | | | | cross-relationships |
| | | | | among the issues. |
| Manage ethical | Apply, evaluate and reassess | Develop strategies to | Discuss as a team impact | Discern ethical perspectives |
| dilemmas specific to | resolution strategies | resolve ethical conflict | of ethical dilemma within | and concepts and |
| interprofessional | for ethical conflict | within team and within a | a plan of care. | consider full implications |
| patient/population | within team and within a | plan of care. | | within a plan of |
| centered care | plan of care. | | | care. |
| situations. | | | | |

What is claimed is:

1. A method for improving patient outcome, the method comprising:
observing a first interview of a simulated patient, wherein, during the first interview, the simulated patient is in a first form;
participating in a second interview of the simulated patient, wherein, during the second interview, the simulated patient is in a second form, and wherein participating in the second interview comprises interacting with the simulated patient;
participating in a third interview of the simulated patient, wherein, during the third interview, the simulated patient is in the first form, and wherein participating in the third interview comprises interacting with the simulated patient; and
based at least in part on the first, second, and third interviews, creating a plan of care for the simulated patient.

2. The method of claim 1, wherein the simulated patient being in the first form comprises the simulated patient being a live person.

3. The method of claim 1, wherein interacting with the simulated patient during the second interview comprises providing one or more inquiries to the simulated patient.

4. The method of claim 1, wherein, during the third interview, the simulated patient is remotely located, and wherein interacting with the simulated patient comprises interacting with the simulated patient via a user interface of a computing device.

5. The method of claim 1, wherein the simulated patient being in the second form comprises the simulated patient being a mechanical dummy.

6. The method of claim 5, wherein the mechanical dummy includes a speaker configured to output a voice of a live person located remotely from the mechanical dummy.

7. The method of claim 6, wherein interacting with the simulated patient during the second interview comprises (i) providing one or more inquiries to the mechanical dummy and (ii) the live person responding to the one or more inquiries via the speaker of the mechanical dummy.

8. The method of claim 1, wherein the simulated patient being in the second form comprises the simulated patient being a virtual avatar displayed via a user interface of a computing device.

9. The method of claim 8, wherein interacting with the simulated patient during the second interview comprises inputting one or more inquiries to the virtual avatar via the user interface of the computing device, wherein the one or more inquiries are routed over a communication network to a remote computing device, and wherein a live person responds to the one or more inquiries via the remote computing device.

10. The method of claim 1, wherein observing the first interview of the simulated patient comprises obtaining information relating to a family history or environmental history of the simulated patient, the method further comprising creating a family map for the simulated patient based on the information relating to the family history or environment history of the simulated patient.

11. The method of claim 1, further comprising, after the second interview of the simulated patient, researching demographical or environmental information of a community of the simulated patient, wherein the created plan of care is further based on the demographical or environmental information of the community of the simulated patient.

12. The method of claim 1, further comprising:
completing a first self-evaluation before the first interview;
completing a second self-evaluation before the second interview;
completing a third self-evaluation before the third interview; and
completing a fourth self-evaluation after creating the plan of care, wherein the first, second, third, and fourth self-evaluations each provide an evaluation of interprofessional values and ethics, roles and responsibilities, communication, and teams and teamwork.

13. The method of claim 1, further comprising evaluating the plan of care for the simulated patient to determine proficiency regarding interprofessional values and ethics, roles and responsibilities, communication, and teams and teamwork.

14. The method of claim 1, wherein the method is carried out by a health professional or a student of a medical school, dental school, pharmacy school, physical therapy school, physician assistant school, pathologist assistant school, nursing school, or psychology school.

15. A system for improving patient outcome, the system comprising:
a user interface;
a processor; and
a computer readable medium storing program instructions, wherein the program instructions are executable by the processor to perform operations comprising:
displaying, via the user interface, a first interview of a simulated patient, wherein, during the first interview, the simulated patient is displayed in a first form;
displaying, via the user interface, a second interview of the simulated patient, wherein, during the second interview, the simulated patient is displayed in a second form;
during the second interview, (i) receiving, via the user interface, one or more inquiries for the simulated patient and (ii) outputting, via the user interface, one or more responses to the one or more inquiries;
displaying, via the user interface, a third interview of the simulated patient, wherein, during the third interview, the simulated patient is displayed in the first form;
during the third interview, (i) receiving, via the user interface, one or more inquiries for the simulated patient and (ii) outputting, via the user interface, one or more responses to the one or more inquiries; and
receiving, via the user interface, a plan of care for the simulated patient, wherein the plan of care is based at least in part on the first, second, and third interviews.

16. The system of claim 15, wherein the simulated patient being displayed in the first form comprises the simulated patient being displayed as a live person.

17. The system of claim 16, wherein displaying the first interview of the simulated patient comprises displaying a pre-recorded interview of the live person, wherein displaying the third interview of the simulated patient comprises displaying a live feed of the live person, wherein receiving one or more inquiries for the simulated patient during the third interview comprises receiving one or more inquiries for the live person, and wherein outputting the one or more responses to the one or more inquiries during the third interview comprises the live person responding to the one or more inquiries via the displayed live feed.

18. The system of claim 15, wherein the simulated patient being displayed in the second form comprises the simulated patient being displayed as a virtual avatar, and wherein receiving one or more inquiries for the simulated patient during the second interview comprises receiving one or more inquiries for the virtual avatar.

19. The system of claim 15, the operations further comprising:
before displaying the first interview, (i) displaying, via the user interface, a first questionnaire including a first self-evaluation and (ii) receiving, via the user interface, one or more answers to the first questionnaire;
before displaying the second interview, (i) displaying, via the user interface, a second questionnaire including a second self-evaluation and (ii) receiving, via the user interface, one or more answers to the second questionnaire;
before displaying the third interview, (i) displaying, via the user interface, a third questionnaire including a third self-evaluation and (ii) receiving, via the user interface, one or more answers to the third questionnaire; and
after receiving the plan of care, (i) displaying, via the user interface, a fourth questionnaire including a fourth self-evaluation and (ii) receiving, via the user interface, one or more answers to the fourth questionnaire, wherein the first, second, third, and fourth self-evaluations each provide an evaluation of interprofessional values and ethics, roles and responsibilities, communication, and teams and teamwork.

20. A non-transitory computer readable medium that stores executable instructions, wherein the executable instructions, when executed by a processor of a computing device, cause the computing device to perform operations for improving patient outcome, the operations comprising:
displaying, via a user interface of the computing device, a first questionnaire including a first self-evaluation and receiving, via the user interface, one or more answers to the first questionnaire;
displaying, via the user interface, a first interview of a simulated patient, wherein, during the first interview, the simulated patient is displayed in a first form;
displaying, via the user interface, a second questionnaire including a second self-evaluation and receiving, via the user interface, one or more answers to the second questionnaire;
displaying, via the user interface, a second interview of the simulated patient, wherein, during the second interview, the simulated patient is displayed in a second form;
during the second interview, (i) receiving, via the user interface, one or more inquiries for the simulated patient and (ii) outputting, via the user interface, one or more responses to the one or more inquiries;
displaying, via the user interface, a third questionnaire including a third self-evaluation and receiving, via the user interface, one or more answers to the third questionnaire;
displaying, via the user interface, a third interview of the simulated patient, wherein, during the third interview, the simulated patient is displayed in the first form;
during the third interview, (i) receiving, via the user interface, one or more inquiries for the simulated patient and (ii) outputting, via the user interface, one or more responses to the one or more inquiries;
receiving, via the user interface, a plan of care for the simulated patient, wherein the plan of care is based at least in part on information obtained during the first, second, and third interviews; and
displaying, via the user interface, a fourth questionnaire including a fourth self-evaluation and receiving, via the user interface, one or more answers to the fourth questionnaire.
